(19) United States
(12) Patent Application Publication
(10) Pub. No.: US 2016/0376040 A1
(43) Pub. Date: Dec. 29, 2016

(54) UNIT DOSE PRODUCTION OF RADIOPHARMACEUTICAL IN FUNCTIONAL IMAGING

(71) Applicant: Siemens Medical Solutions USA, Inc., Malvern, PA (US)

(72) Inventors: Danny Bingham, Knoxville, TN (US); Michael Nazerias, Knoxville, TN (US); Eric Webster, Knoxville, TN (US); Steven Zigler, Knoxville, TN (US)

(21) Appl. No.: 14/602,304

(22) Filed: Jan. 22, 2015

(51) Int. Cl. B65B 3/00; G06Q 50/22; G06Q 10/08

(52) U.S. Cl. CPC B65B 3/003; G06Q 10/083; G06Q 50/22

(57) ABSTRACT

Radiopharmaceuticals for functional imaging are produced. The manufacturer of the radiopharmaceutical dispenses and packages in unit dosage. The unit dosage package is a standard amount, such as is used in over-the-counter drugs, rather than being patient specific, such as for a filled prescription. The containers with the unit dose are then delivered to the healthcare facility for use or further dispensing. This arrangement allows for pharmacists to be replaced by chemists at the manufacturer since the unit dose may be dispensed and packaged using GMP instead of pharmacy practice. This arrangement results in a different item being delivered to healthcare facilities for functional imaging.

### BACKGROUND

The present embodiments relate to production of radiopharmaceuticals. Radiopharmaceuticals are used for functional imaging, such as for positron emission tomography (PET) or single photon emission computed tomography (SPECT). The radiopharmaceuticals have a short half-life, so are produced near the healthcare facilities using the radiopharmaceutical for PET or SPECT scanning. The radiopharmaceuticals are produced in batches on demand and then dispensed and packaged for specific patient subscriptions. The manufacturers employ pharmacists to dispense and package the patient specific dosages.

PET radiopharmaceuticals are manufactured under good manufacturing practice (GMP) requirements but are dispensed under pharmacy practice. A batch of many doses is created using GMP, and then patient specific subscriptions are dispensed from the batch using pharmacy practice. Nuclear pharmacists are currently employed throughout the radiopharmaceutical industry in the United States to dispense these doses to the market. Since pharmacists are regulated under state guidelines, dispensing under the practice of pharmacy creates regulatory complexity (e.g., 50 states with different regulations and/or interpretations), which increases the risk of noncompliance.

In Europe, pharmacy regulation is handled at the healthcare facilities associated with the functional imaging scanners. A multi-dose vial is delivered to a given healthcare facility. A healthcare provider at that healthcare facility then dispenses from the multi-dose vial into to patient specific dosages. Providing multi-dose vials to the healthcare facilities may result in waste or delivery complexity.

### BRIEF SUMMARY

By way of introduction, the preferred embodiments described below include methods and systems for producing radiopharmaceuticals for functional imaging. The manufacturer of the radiopharmaceutical dispenses and packages in unit dosage. The unit dosage package is a standard amount, such as is used in over-the-counter drugs, rather than being patient specific, such as for a filled prescription. The containers with the unit dose are then delivered to the healthcare facility for use or further dispensing. This arrangement allows for pharmacists to be replaced by chemists at the manufacturer since the unit dose may be dispensed and packaged using GMP instead of pharmacy practice. This arrangement results in a different item (e.g., unit dose container and label information) being delivered to healthcare facilities for functional imaging.

In a first aspect, a method is provided for producing radiopharmaceutical for functional imaging. The radiopharmaceutical with a half-life of less than one day is generated in a vial in a shielded area or device, such as a hot cell. The radiopharmaceutical is packaged from the vial into a plurality of syringes each of a labeled unit dosage. The syringes are distributed to different healthcare facilities having patients with orders for the functional imaging.

In a second aspect, a system is provided for producing radiopharmaceutical for functional imaging. A cyclotron or a generator is configured to manufacture a radiopharmaceutical. A hot cell or shielding device is used for dispensing the radiopharmaceutical. Containers are provided for receiving unit dosage amounts of the radiopharmaceutical. Labels on or for the containers include a batch and time pursuant to federal regulation and are free of patient name.

In a third aspect, a method is provided for producing radiopharmaceutical for functional imaging. A cyclotron or a generator is used to manufacture a drug for positron emission tomography. The drug is dispensed in unit dosage into containers without an amount dictated by a patient prescription. The containers with the unit dosage are packaged for transport to positron emission tomography scanners. The dispensing and packaging into the containers with unit dosage are performed by a chemist and not a pharmacist.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 illustrates one approach for production of radiopharmaceuticals with pharmacy practice;

FIG. 2 illustrates an embodiment of production of radiopharmaceuticals with good manufacturing practice;

FIG. 3 is a flow chart of one embodiment of a method for producing radiopharmaceutical for functional imaging; and

FIG. 4 is a block diagram of a system, according to one embodiment, for producing radiopharmaceuticals for functional imaging.

### DETAILED DESCRIPTION OF THE DRAWINGS AND PRESENTLY PREFERRED EMBODIMENTS

By packaging the radiopharmaceutical in unit doses, a different item is created and delivered for functional imaging. For example, a container with unit dose and corresponding labeling is provided to healthcare facilities instead of filled prescriptions.

This different item may result in a difference in regulation. A GMP filling process is used for PET imaging drugs. A standardized workflow for drug filling, packaging and distribution eliminates the need for a licensed pharmacy and licensed pharmacists. Compounding guidelines or other pharmacy regulation may not be adequate for PET radiopharmaceuticals. Regulating the filling, packaging and distribution of PET drugs under GMP may provide controls under a standard federal code (e.g., 21 CFR 212), resulting in significant simplification of regulatory compliance for delivering radiopharmaceuticals to the market as compared to fifty different regulations or interpretations under pharmacy practice. The elimination of dispensing under pharmacy practice may also reduce manufacturing costs for labor, since the costs of pharmacists are greater than chemists used in GMP.

The practice of pharmacy is removed from production of radiopharmaceuticals, such as PET drugs. Instead, containers with unit dose of radiopharmaceuticals are packaged for delivery to healthcare facilities to be used with functional imaging scanners. Dispensing sterile injectable drugs under the practice of pharmacy may require increased regulatory complexity, increasing the risk of noncompliance. From a business sustainability perspective, removal of pharmacy practice may reduce costs. There may be an advantage to the sustainability and growth of the business by eliminating the practice of pharmacy and hiring chemists to fill and distribute unit doses under GMP. Patient safety may be improved by operating under one uniform set of regulations.

FIG. 1 illustrates one approach using pharmacy practice to dispense and package radiopharmaceuticals for distribution or transport to different healthcare facilities. PET radiopharmaceuticals are manufactured following current good manufacturing practice (cGMP), such as provided by federal regulations (e.g., 21 C.F.R. 212). The final drug product is released to a pharmacist for dispensing into dose syringes or vials in accordance with their respective state's pharmacy practice regulations and for specific patients. These doses are dispensed in an ISO class 5 area (e.g., within a hot cell) following sterile dispensing guidelines (e.g., USP <797> for many states). FIG. 1 shows some example pharmacy practices in dispensing and packaging, including daily reporting, prescription printing, syringe labeling, dispensing and dose dilution, and packaging.

Under the pharmacy practice illustrated in FIG. 1, aseptic processing for manufacturing and pharmacy dispensing are subject to simulations using liquid growth media. There are operator media simulations in place to confirm the operator's ability to maintain aseptic integrity of preparing final product vials, as well as process media fill simulations to confirm the aseptic integrity of the manufacturing process. Media simulations are in place for dose dispensing as well as dose dilution.

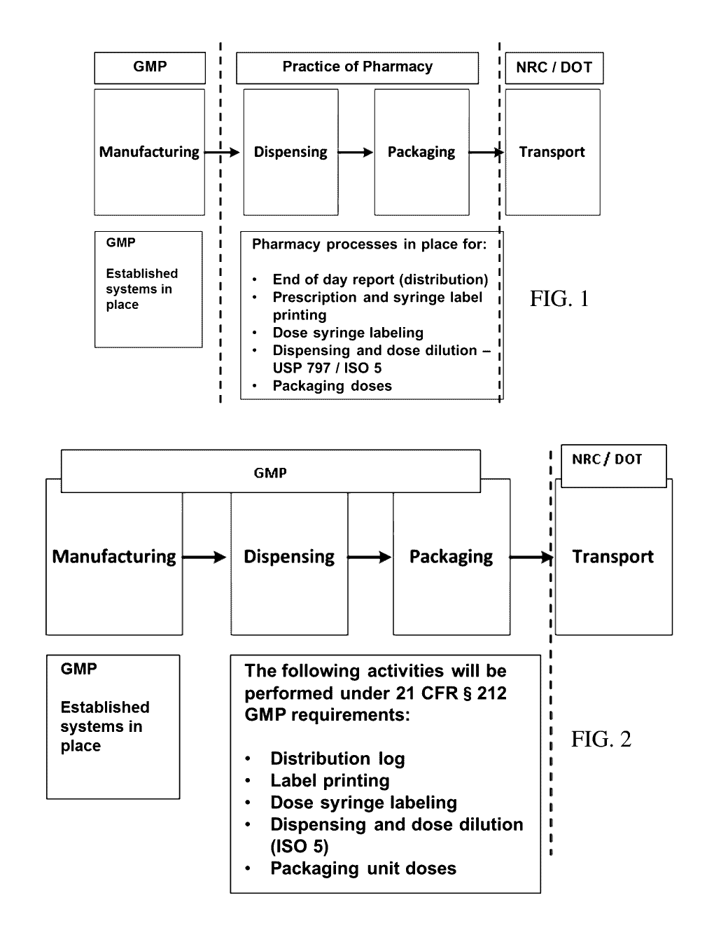

FIG. 2 represents a GMP-based approach for unit dose distribution without pharmacy practice prior to distribution. Rather than dispensing, packaging and delivering prescriptions of drugs, unit dose containers are used. Dispensing activities regulated by existing pharmacy laws, which vary from state-to-state, may instead be regulated under uniform requirements (e.g., codified in 21 C.F.R. 212 or other federal regulation). The cGMP manufacturing process is extended to create unit dose containers for distribution. The final drug product is filled into customer specified dosage units with subsequent distribution in compliance federal regulation. The packaging is also subjected to federal regulation (e.g., to FDA compliance inspections).

Due to changes to GMP based dispensing and packaging of unit dose rather than patient specific dose, aseptic qualifications and product stability testing may change or include added components. Procedures to address the filling, labeling, and distribution of the doses may change, such as requiring a distribution log as opposed to an “end of day” report, requiring unit dose label printing as opposed to prescription label printing, and providing unit dose as opposed to patient specific dose. FIG. 2 shows the activities under 21 C.F.R. 212 associated with dispensing and packaging, but other activities for the same or different federal regulations may be provided. This shift from pharmacy to GMP filling and distribution may provide a public health benefit.

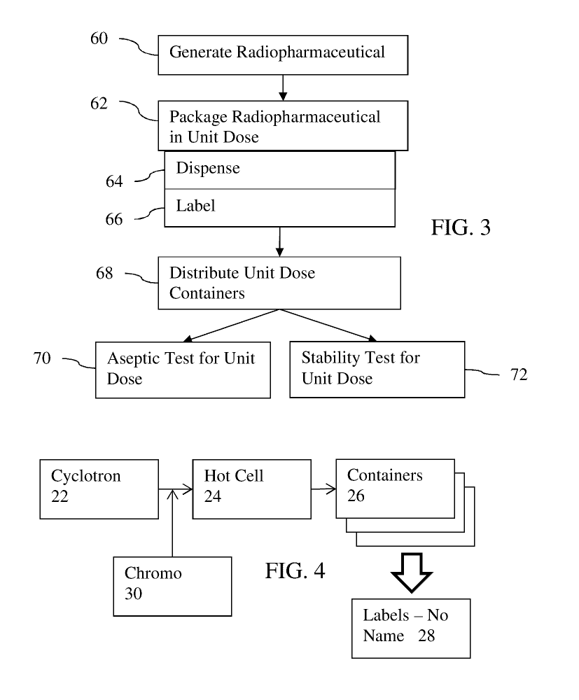

FIG. 3 shows a method for producing radiopharmaceuticals for functional imaging. The method of FIG. 3 is implemented with or as part of the system of FIG. 4 or other systems. The method provides packaged unit doses of radiopharmaceutical. A given patient may need more, less, or just the unit dose. Physicians may tailor or set the prescription amount based on the unit dose. For the manufacturer, the unit dose is provided regardless of what dosage is appropriate for a given patient. Rather than filling prescriptions, the radiopharmaceutical manufacturer creates unit dose items to be used by physicians and patients. The pharmacy practice is removed from the manufacture and delivery of the radiopharmaceutical.

Additional, different, or fewer acts may be performed. For example, act 60, 70, and/or 72 are not performed. The acts are performed in the order shown or a different order. Acts 72 may be performed before, after, or at a same time as act 70. Act 66 is performed after, at the same time, or before act 64.

In act 60, a radiopharmaceutical is generated. A drug for use in functional imaging is manufactured. For example, FDG is created. Other drugs designed to respond to tissue or body function (e.g., uptake or tagging to lesion) with radioactive characteristics may be generated. Any now known or later developed radiopharmaceutical for PET, SPECT or other functional imaging is manufactured. These drugs cause detectable gamma emissions. By responding to tissue function, the emissions are concentrated at locations of that function.

The radiopharmaceutical is generated with a cyclotron or a generator. A generator may be used for generating drugs with a longer half-life, but may not be easily available. Cyclotrons may be used to manufacture radiopharmaceuticals with a shorter half-life, such as less than one day (e.g., less than three, two, or even one hour). The cyclotron is used to cause the radiopharmaceuticals to emit positron radiation.

The radiopharmaceutical is manufactured in a vial of a hot cell. The hot cell is a container, vat, or room or other shielded device maintaining ISO class 5 level radiation protection, sterilization, and/or isolation. For example, the radiopharmaceutical created using the cyclotron is in a vial in the hot cell. The dispensing of act 64, labeling of act 66, and/or packaging of act 62 are performed in this isolation of the hot cell.

The generation of the radiopharmaceutical in the vial is performed as part of good manufacturing practice (GMP). Any standard of GMP may be used, such as the current GMP (cGMP). The generation may be performed pursuant to federal standards, such as 21 C.F.R. 212 or other United States Food and Drug Administration (FDA) regulation. This manufacturing of the radiopharmaceutical is performed without a pharmacist. Technicians, chemists, or others manufacture the radiopharmaceutical, resulting in the batch vial of the hot cell of radiopharmaceutical. Any now known or later developed manufacturing of the radiopharmaceutical prior to dispensing may be used.

The GMP-manufactured radiopharmaceutical may be tested. For example, the stability (e.g., half-life) and/or aseptic integrity of the radiopharmaceutical at least up to the point of generating the vial in the hot cell are tested. As another example, the composition of the radiopharmaceutical is tested. A chemist or other technician uses chromatograph equipment to test composition. Gas chromatography, thin layer chromatography, high pressure liquid chromatography or other chromatography equipment is used to determine whether the radiopharmaceutical has the desired or tolerated composition. Where the manufacture of the radiopharmaceutical involves complex syntheses and quality control processes (e.g., some newer PET drug products), more complex equipment and/or testing processes performed by chemists may be used.

In act 62, the radiopharmaceutical is packaged. For distribution in act 68, the radiopharmaceutical is packaged for shipment. The packaging may be in any container, such as vials or syringes. The vials or containers may be sealed, such as stoppered and/or placed in a no-prick container. The packaging may or may not include isolation, such as lead lined boxes. The packaging may or may not include shock protection, such as Styrofoam.

To package the radiopharmaceutical, the radiopharmaceutical is dispensed from the vat, batch vial or other multi-dose container for manufacture into unit dose containers in act 64. For example, the multi-dose vial contains radiopharmaceutical. By pouring, sucking, or other transfer, the radiopharmaceutical is dispensed into unit dose syringes or vials. The drug is dispensed in unit dosage into containers. For example, 10-50 unit dose containers may be filled from a batch of radiopharmaceutical.

The amount for the unit dose containers is dictated by the unit dose, such as a 10 millicurie dose. A plurality of unit dose containers is filled from the manufactured radiopharmaceutical. The amount in each unit dose container is dictated by a common dosage used for functional imaging or a customer requested standard dose, and not by a specific patient prescription. The amount needed for a given patient may be different than or the same as the unit dose. Different unit doses (i.e., amounts per container) may be packaged. The packaging and dispensing occur based on the unit dose rather than a specific fill of a prescription for a specific patient.

The radiopharmaceutical in the unit dose containers may be diluted to provide the desired unit dose in sufficient volume to avoid undesired radiation loss. Any sterile dilution substance may be used, such as 0.9% sodium chloride for injection. Mixing is provided by withdrawal of the PET imaging agent followed by withdrawal of the diluent.

To package the radiopharmaceutical, the unit dose containers of radiopharmaceutical are labeled in act 66. A label is printed and added to the unit dose container. Alternatively, the label is printed on or written on after already being on the unit dose container.

The labeling is performed prior to or after dispensing. Since a unit dose not specific to a given patient is being packaged, the labels for the containers may be pre-printed and added prior to dispensing in act 64. The containers may be received from a supplier with already printed labels. Alternatively, the labels are added to the unit dose containers after dispensing.

The labels include information about the unit dose. For example, the labels include the unit dosage, radiopharmaceutical information (e.g., name of the drug and/or composition of the drug), batch (e.g., multi-dose vial information), and time information (e.g., time of manufacture and/or dispensing). Other information may be included, such as half-life.

The label information may be dictated by regulation. Since the packaging is performed under GMP and federal regulation for unit dosage, the labeling information is dictated, at least in part, by the federal regulation. For example, the time dose, batch for the multi-dose vial, and dose are included. Unlike pharmacy practice, the patient name or patient identifier is not included. Lot number may or may not be included. The labeling satisfies the federal regulation rather than state pharmacy or USP <797> regulation.

Since the unit dose container is not specific to a patient or prescription, patient identification is not provided on the label. Any patient may use any amount of the radiopharmaceutical in the unit dose container. A physician or pharmacist at a healthcare institution may receive any of the unit dose containers and fulfill the prescribed dose for a given patient from the unit dose container or containers. In alternative embodiments, a patient identification is provided on the unit dose container label.

The labeled unit dose containers of radiopharmaceutical are packaged for shipping. Different packaging may be used for different types of transport. Alternatively, a same packaging is used regardless of the type of transport. The labeled unit dose containers are packaged for transport by vehicle (e.g., medical delivery car or van) to the functional imaging scanners, such as to PET scanners. The scanners are located at healthcare facilities. One or more patients are scheduled to be scanned at a given time. The unit dose containers are packaged for shipping to the healthcare facilities based on the patient scan scheduling, or the patient scan scheduling is based on the expected arrival of the unit dose containers.

The packaging of act 62 is performed as part of GMP. The packaging is performed pursuant to or based on federal regulations (e.g., United States Food and Drug Administration regulation). Since unit dosage containers are being labeled and packaged, a chemist or non-pharmacist performs the packaging (e.g., dispensing and labeling). The packaging, as well as the manufacturing, of the radiopharmaceutical is performed without a pharmacist. Due to the use of unit dose containers, the pharmacy practice and corresponding state regulation is removed from the process until the healthcare facility receives the shipped unit dose container or containers.

The cost of production, including the cost of quality control and the cost of compliance with regulation, is increasing. Due to market pressures, the price of the end-product (e.g., radiopharmaceutical) paid by the healthcare facilities is decreasing. For example, FDG represents greater that 90% of most manufacturers volume of radiopharmaceutical. The price of FDG has eroded about 9% per year since US approval in 1994.

A major component of radiopharmaceutical manufacturer cost is labor, specifically pharmacists. Depending on the size and dose volume for that site, two or more pharmacists may be employed at each manufacturing site (e.g., one site for each state or major city). Pharmacy law requires the manufacturer to have more than one pharmacist on staff to cover the full production cycle. In addition and according to at least one state, certain maintenance activities (e.g., cyclotron maintenance) require a pharmacist to be on-site to satisfy the pharmacy law requirements, even though the pharmacist is not performing the maintenance activity nor dispensing a drug product.

By manufacturing and packaging as part of GMP rather than GMP and pharmacy practice, chemists may be hired to manufacture, fill, and distribute unit dosages of PET or other functional imaging drugs. Pharmacists are not used. Utilization of chemists will be a better long term strategy than pharmacists since the radiopharmaceuticals currently in development use complex synthetic and analytical chemistry techniques. A chemist may be better trained for using the various analytical instruments (e.g., chromotography equipment) and have a more comprehensive background in organic chemistry appropriate for these new radiopharmaceuticals. Labor costs may also be more reasonable, resulting in cost savings.

Since the manufacturing, dispensing, and packaging are performed pursuant to federal regulation and not state pharmacy regulation, there may be reduced regulatory complexity. Regulation under one uniform set of federal regulations (e.g., 21 C.F.R. 212) interpreted by one agency may simplify regulatory compliance structure and reduce the risk of noncompliance. Where state pharmacy regulation is part of the dispensing and packaging, fifty different state Boards of Pharmacy (BOP) regulations must be followed. These state regulations are not harmonized as each state has their own set of pharmacy regulations. Each state may enforce even the same regulations differently. In addition, many states do not have pharmacy laws that are specific to nuclear pharmacy. Most pharmacy law is written for traditional retail pharmacy and does not take into account the relevant differences of nuclear pharmacy practice. For example, many states require a mortar and pestle, microscope and patient counseling area on-site even where a mortar and pestle and microscope are not used for radiopharmaceuticals. Patients never visit and are not even allowed on the manufacturing premises. A patient counseling area is not needed. Since many of the regulations are not specific to nuclear pharmacy, the state BOPs struggle to apply the requirements in nuclear medicine. GMP regulations do not have these requirements and may be applied more uniformly.

Each site of manufacture may be used to back up another site if there is a production failure. This backup minimizes the impact of a site production failure on customers (e.g., healthcare facilities). The backup criteria may result in additional needed licensing permits in the United States. The result is maintaining 200+ individual pharmacy licenses and/or permits (e.g., resident and non-resident pharmacy permits). This large number of licensing and permits is a significant challenge to manage, but is unnecessary if the radiopharmaceutical is filled and distributed under GMP.

With recently passed pharmacy compounding legislation, more and more state BOP inspectors treat radiopharmaceutical manufacturing sites as sterile compounding facilities even though compounding is not performed as the radiopharmaceutical are manufactured under an approved abbreviated new drug application (ANDA). However, the state inspectors struggle to understand these differences and try to enforce their sterile site regulations. This sterile compounding issue creates more complexity in manufacturing and packaging radiopharmaceuticals.

By packaging radiopharmaceuticals under GMP, the filling and packaging activities may be subjected to FDA compliance inspections. Patient safety may be increased. Rather than end of day reporting of pharmacy practice, a distribution log of FDA practice is maintained.

In act 68, the unit dose containers (e.g., syringes) are distributed to different healthcare facilities. The manufacturer provides the packaged unit dose containers for shipping or transport. By providing the packaged unit dose containers, the manufacture provides for distribution to different healthcare facilities with patients having orders for functional imaging.

The manufacturer, a shipping company, a medical supply distributor, or healthcare facilities deliver the packaged unit dose containers to the healthcare facility or other patient location. The patient may then ingest or be injected with the radiopharmaceutical of a patient specific dosage from one or more unit dose containers in preparation for functional imaging.

In act 70, aseptic testing one or more of the unit dose containers is performed. Aseptic testing may be performed at various times during manufacture and packaging. Since unit dose containers are being distributed, aseptic testing may be performed for delivered unit dose containers. For example, one or more syringes are acquired by the manufacture after distribution to one or more of the different healthcare facilities or scanner locations (e.g., location of PET scanners). The acquired syringes used for aseptic testing.

Incorporating the dispensing process as part of the manufacturing operations under GMP may result in modification of aseptic processing qualifications to incorporate filling and distribution to comply with 21 CFR 212. The aseptic testing may be expanded to include delivered unit dose containers.

In act 72, the radiopharmaceutical of one or more unit dose containers may be tested for stability. Rather than or in addition to testing the radiopharmaceutical of the bulk or multi-dose vial for stability, samples of the radiopharmaceutical of the individual unit dose containers may be tested for stability. The half-life, dose as a function of time, or other measure of expiration may be performed by unit dose (e.g., in a sampling of syringes to be distributed or as distributed). The stability over an expiration period of the unit dose is tested.

FIG. 4 shows one embodiment of a system for producing radiopharmaceuticals for functional imaging. The system is used in the method of FIG. 3, the approach of FIG. 2, or other method. Labeled, unit dosages of radiopharmaceutical are created for shipping to users or consumers (e.g., healthcare facilities with patients to undergo functional imaging).

A cyclotron 22 is configured to manufacture a radiopharmaceutical. The cyclotron 22 is configured by hardware, software, and/or firmware. The cyclotron 22 is an accelerator for causing a pharmaceutical to emit gamma radiation. Other equipment may be used to cause the pharmaceutical to be radioactive, such as a generator. Other equipment may be used to create the pharmaceutical before or after use of the cyclotron 22.

The manufactured radiopharmaceutical is provided in a hot cell 24 for dispensing and/or packaging the radiopharmaceutical. The hot cell 24 is a vat meeting sterility and/or radiation isolation standards, such as ISO 5. Alternatively, a room or other facility meeting the sterilization and/or isolation standards is used.

The hot cell 24 includes a vial or other bulk container of the radiopharmaceutical. The bulk container holds multiple dosages of the radiopharmaceutical in any concentration.

Unit dose containers 26 receive the unit dosage amounts of the radiopharmaceutical. The unit dose containers 26 are vials, syringes, or vials and syringes. Other containers may be used. Where the radiopharmaceutical is a solid, the container 26 may be a coating, a pill holder, or the solid itself.

The container 26 may be the same or different type and/or size container as used for filling prescriptions. Since the containers 26 are being used for unit dose, the radiopharmaceutical in combination with the container 26 is different than the radiopharmaceutical in containers filled for a prescription. This difference may be in an aggregate, since every container 26 is filled as a unit dose. Some unit dose containers 26 may be the same as a patient prescribed dose but other unit dose containers 26 may be different than the prescribed amounts for a collection of patients. For a given bulk vial of the radiopharmaceutical, all of the resulting containers 26 have unit dose (e.g., same unit dose or two or more unit dosages). Of those containers 26, some are of a different dosage than is to be used for particular patients, making some or all of the containers 26 different than in filling prescriptions.

Another difference is in the labeling. The printing on the labels 28 of the unit dose containers 26 is different than the printing for prescriptions. No name or patient identifier is provided for the unit dose containers 26. The batch information is provided for the unit dose containers 26. The labeling may have some information and printing in common with prescriptions, such as a time of manufacture, expiration, and/or half-life. The labels 28 are printed to satisfy federal regulation rather than pharmacy regulation.

The labels 28 are on the containers 26. Each unit dose container 26 of a given unit dose from a same batch is labeled the same. The label may be different for different batches of the radiopharmaceutical, such as having different batch and expiration information. The dose amount may be the same for different batches.

The hot cell 24, containers 26, and labels 28 are used by a chemist pursuant to good manufacturing practice. A pharmacist operating pursuant to pharmacy practice is not used since unit dosage is being dispensed rather the filling prescriptions. The chemist or other non-pharmacist technician dispenses the radiopharmaceutical while the radiopharmaceutical is in the hot cell 24. The radiopharmaceutical is dispensed into the containers 26 in unit dosage with or without dilution. The containers 26 are labeled with the labels 28 before or after filling.

The chemist may also use chromograph 30. Any type of chromograph 30 may be used, such as a thin layer, high pressure liquid, or gas chromograph 30. The chromograph 30 is configured by hardware, firmware, and/or software to test the radiopharmaceutical. The chemist configures and/or uses the chromograph 30 for testing. The chemist verifies that the proper composition is provided.

The containers 26 with the labels 28 are provided to patients for functional imaging. The patient ingests or is injected with the radiopharmaceutical. The amount used for given patient is minimized given characteristics of the patient, the radiopharmaceutical, and the body or tissue function being examined (e.g., diagnosed). Accordingly, a given patient may need less than a unit dose, the unit dose, and/or more than a single unit dose. The needed number of unit doses are used to fill the prescription for that patient.

The radiopharmaceutical binds, tags, is activated, or otherwise gathers at locations of interest in the patient. For example, the radiopharmaceutical tends to collect more at locations of uptake in the patient. As a result, more emissions of gamma radiation occur from these locations. After sufficient time for the radiopharmaceutical to progress or perfuse to the location of interest in the patient, the patient is placed in a PET or other functional imaging scanner. Emissions caused by the radiopharmaceutical are detected by sensors of the scanner. The gamma radiation impedes upon scintillation crystals, causing light. Light detectors (e.g., photo-multiplier tubes) detect the light. The location of the detectors with or without timing information is used to reconstruct, by a processor, the distribution of locations associated with emissions. An image of the distribution and/or activity at the different locations is generated by the processor for diagnosis by the physician.

The examples above relate to PET. SPECT may similarly use the radiopharmaceutical manufacture and distribution described herein, including GMP creation of unit dose vials for distribution without pharmacy.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (We) claim:

1. A method for producing radiopharmaceutical for functional imaging, the method comprising:
generating, in a vial of a shielded area, the radiopharmaceutical with a half-life of less than one day;
packaging the radiopharmaceutical from the vial into a plurality of syringes each of a labeled unit dosage; and
distributing the syringes to different healthcare facilities having patients with orders for the functional imaging.

2. The method of claim 1 wherein generating comprises manufacturing with a cyclotron or generator.

3. The method of claim 1 wherein generating comprises generating the radiopharmaceutical with the half-life of less than three hours.

4. The method of claim 1 wherein packaging comprises dispensing from the vial to the syringes and labeling the syringes with the unit dosage.

5. The method of claim 1 wherein packaging comprises labeling the syringes with the unit dosage not specific to any of the patients.

6. The method of claim 1 wherein generating and packaging are performed as part of good manufacturing practice.

7. The method of claim 6 wherein the good manufacturing practice including the packaging is performed under United States Food and Drug Administration regulation.

8. The method of claim 1 wherein packaging comprises labeling the syringes with a batch label for the vial and a time and without any names of the patients.

9. The method of claim 1 wherein packaging is performed by a chemist.

10. The method of claim 9 wherein generating comprises testing by the chemist with chromatograph equipment.

11. The method of claim 1 wherein generating and packaging are performed without a pharmacist.

12. The method of claim 1 further comprising aseptic testing one of the syringes after distribution to one of the different healthcare facilities.

13. The method of claim 1 further comprising stability testing of the radiopharmaceutical in one of the syringes over an expiration of the unit dose.

14. A system for producing radiopharmaceutical for functional imaging, the system comprising:
a cyclotron or generator configured to manufacture a radiopharmaceutical;
a hot cell or shielding device for dispensing the radiopharmaceutical;
containers for receiving unit dosage amounts of the radiopharmaceutical; and
labels for the containers, the labels including a batch and time pursuant to federal regulation and being free of patient name.

15. The system of claim 14 wherein the containers comprise vials, syringes, or vials and syringes.

16. The system of claim 14 wherein the hot cell or shielding device, containers, and labels are used by a chemist and not a pharmacist pursuant to good manufacturing practice.

17. The system of claim 16 further comprising a chromatograph configured for testing the radiopharmaceutical by the chemist.

18. A method for producing radiopharmaceutical for functional imaging, the method comprising:
manufacturing, with a cyclotron or a generator, a drug for positron emission tomography;
dispensing the drug in unit dosage into containers without an amount dictated by a patient prescription; and
packaging the containers with the unit dosage for transport to positron emission tomography scanners;
wherein the dispensing and packaging into the containers with unit dosage are performed by a chemist and not a pharmacist.

19. The method of claim 18 wherein manufacturing, dispensing, and packaging are performed pursuant to federal regulation and not state pharmacy regulation.

20. The method of claim 18 further comprising:
aseptic testing for at least one of the containers after delivery to a facility for one of the positron emission tomography scanners; and
stability testing the drug at the unit dosage.
